(19) United States
(12) Patent Application Publication
(10) Pub. No.: US 2011/0010307 A1
(43) Pub. Date: Jan. 13, 2011

(54) METHOD AND SYSTEM FOR RECOMMENDING ARTICLES AND PRODUCTS

(75) Inventors: Keith M. Bates, Toronto (CA); Julian Paas, Mississauga (CA); Jiang Su, Ottawa (CA); Biao Wang, Toronto (CA); Bo Xu, Toronto (CA); Pendar Yousefi, Toronto (CA)

Correspondence Address: VENABLE LLP, P.O. BOX 34385, WASHINGTON, DC, 20043-9998, US

(73) Assignee: KIBBOKO, INC., Toronto (CA)

(21) Appl. No.: 12/698,087

(22) Filed: Feb. 1, 2010

Related U.S. Application Data
(63) Continuation-in-part of application No. 12/558,132, filed on Sep. 11, 2009.
Application No. 12/558,132 is a continuation-in-part of application No. 12/501,221, filed on Jul. 10, 2009.

(51) Int. Cl. G06Q 99/00; G06Q 30/00; G06N 5/02

(52) U.S. Cl. 705/347; 706/46; 705/26.7

(57) ABSTRACT

In a data processing system, a method of recommending articles and products to a user is disclosed. The method creates a frequency vector in relation to the content of an article, frequency vectors in relation each of one or more products from intermediate data. The method compares the vectors to determine a content similarity measure, and provides as output a list of one or more products having the highest content similarity measures. The method may also determine a correlation measure. An electronic data processing system for recommending articles and products to a user is also disclosed. The system includes modules to receive article information and product information, a correlation module to determine a content similarity measure between the article and each of the products and, a multiplexer module for providing a list comprising the article and the products associated having the highest content similarity measure.

### CROSS-REFERENCE TO RELATED APPLICATION

This application claims priority to and is a continuation-in-part of U.S. application Ser. No. 12/558,132 entitled “METHOD AND SYSTEM FOR RECOMMENDING ARTICLES,” filed Sep. 11, 2009, which claims the priority of U.S. application Ser. No. 12/501,221 entitled “METHOD AND SYSTEM FOR RECOMMENDING ARTICLES,” filed Jul. 10, 2009, both of which are incorporated herein by reference in their entirety.

### FIELD

The present invention relates to an on-line method and system for recommending articles and products to users, based on user input.

### BACKGROUND

A recommender system is a type of electronic data processing system. A recommender system recommends items including, without limitation, articles and products to a user.

In this patent application, “article” means any content, data or material that can be delivered on-line, and includes but is not limited to text, such as newspaper or magazine articles, books and book chapters, advertisements, which has textual content that can be read by (or to) an end user, or translated for their viewing or reading. Articles could also include blogs, tweets, PowerPoints or any computer file with meaningful textual data (words) that could be read by a reader.

In this patent application, “product” refers to any tangible or intangible ware, good or service that can be purchased on-line including books, music, movies, television shows, applications, mobile apps, video games, electronics, home and garden products, toys, sports, kids and baby products, tools, grocery products, automobiles, computers, office products, among many others. It could also include a variety of services, including without limitation, health-related services, financial planning advice, legal services, accounting services, etc.

Current recommender systems have a number of disadvantages and present a number of problems.

One disadvantage relates to recommending appropriate products and services. For example, when a user accesses the Internet to browse or otherwise read or interact with articles, opportunities to recommend appropriate or suitable products or services—such as products and services relevant to the browsing session—may be limited. One challenge is that often there is no appropriate fit between a user's browsing activities and the products and services being offered, leading to lost opportunities for commerce and reduced engagement by the user. Often product offerings directed to a user are not personalized or customized. Product offerings may not give the opportunity to purchase specific goods or services, or goods or services of interest to the user. As well, product offerings are often unattractively displayed alongside content which is being recommended or displayed.

A goal of the present application may be to address one or more the above-noted disadvantages and weaknesses of current recommender systems.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention is directed to a method of recommending articles and products to a user, in a data processing system.

In one embodiment of the present invention, the method comprises (a) receiving content of an article at an input of a processor; (b) the processor creating a frequency occurrence vector in relation to the content; (c) receiving an intermediate data set in relation to each of one or more products at an input of the processor; (d) the processor creating intermediate data vectors in relation to each of the one or more products from the intermediate data; (e) the processor comparing the frequency occurrence vector to the intermediate data vectors to determine a content similarity measure between the frequency occurrence vector and each of the intermediate data vectors; and, (f) providing at an output of the processor, a list comprising one or more products associated with the intermediate data vectors having the highest content similarity measure to the frequency occurrence vector. In another embodiment of the present invention, the steps of the method may be carried out using an electronic recommender system.

In one embodiment, the method may further comprise: (a) receiving content of a second article at the input of the processor; (b) repeating steps b-f of claim 1, thereby producing a second list comprising a second set of one or more products associated with the intermediate data vectors having the highest content similarity measure to the frequency occurrence vector of the content of the second article; (c) the processor applying weighting factors to the products found on the list and second list; (d) the processor adding the weighting factors associated with products found on both the list and the second list, thereby combining the lists; and, (e) the processor presenting a list comprising the one or more products having the highest aggregate weighting factors.

In a further embodiment of the present invention, the method uses a cosine similarity measure to determine the content similarity measure between the frequency occurrence vector and each of the intermediate data vectors.

In a further embodiment of the present invention, the information about the article may be included in the list comprising one or more products associated with the intermediate data vectors having the highest content similarity measure to the frequency occurrence vector. In a yet further embodiment of the present invention, a link to each vendor offering said one or more products for purchasing the said one or more products on the list may be included.

In one embodiment of the present invention, the list comprising one or more products associated with the intermediate data vectors having the highest content similarity measure to the frequency occurrence vector, is determined by selecting those products having the highest n content similarity measures, where n is an integer. In another embodiment, the list is determined by selecting those products having a content similarity measure which exceeds an operator determined threshold.

In a further embodiment of the present invention, the method further comprises displaying, in a user recommendation electronic widget, the list comprising the article and the one or more products associated with the intermediate data vectors having the highest content similarity measure to the frequency occurrence vector on a user display screen.

In a yet further embodiment, the method further comprises: (a) receiving from a user of said user recommendation electronic widget, a signal indicating the user's desire to purchase one of the one or more products; and, (b) transmitting to a vendor of said desired product, using a user recommendation electronic widget, a signal indicating the user's desire to purchase the said one desired product.

A method of recommending articles and products to a user and facilitating user purchase of one or more of the recommended products is also disclosed. The method comprises: (a) receiving at a user display a list comprising a recommended article and one or more recommended products; (b) receiving from a user using a user recommendation electronic widget, a signal indicating the user's desire to purchase one of the recommended products; (c) transmitting to a vendor of said desired product, using a user recommendation electronic widget, a signal indicating the user's desire to purchase the said product.

In a further embodiment of the present invention, a method of recommending products is disclosed. This method comprises: (a) receiving an article using an electronic user recommendation system; (b) receiving information for each of one or more products using said electronic user recommendation system; (c) determining a content similarity measure between the article and the information for each of said plurality of products using said electronic user recommendation system; and (d) generating a list comprising the article and one or more of said plurality of products having the highest content similarity measure using said electronic user recommendation system. In one embodiment, this method may further comprise: (a) receiving input from a plurality of users on items co-visited within a given time interval using an electronic user recommendation system; (b) receiving input from a new user on an item visited; and (c) generating a recommended product to the new user by selecting the product which is most frequently co-visited with the item visited by the new user. In another embodiment, this method may further comprise (a) determining the total number of unique visits for each item visited; and, (b) applying a weighting factor to the number of determined co-visits by dividing the number of co-visits by the number of visits to the item visited by the new user. In yet another embodiment, this method may comprise: (a) receiving input from a plurality of users on items co-visited within a given time interval using an electronic user recommendation system; (b) receiving a history of items visited by a new user using an electronic user recommendation system; (c) calculating a personal co-visitation score for the new user, according to the following formula using an electronic user recommendation system:

$$\frac{\frac{f ( a , candidate )}{f ( a )} + \frac{f ( b , candidate )}{f ( b )} + … + \frac{f ( n , candidate )}{f ( n )}}{n}$$

where (a, b, . . . n are items visited by the user); f(n,candidate) is the number of people who have co-visited item n and the candidate product; and, f(n) is the number of people who have visited item n; and n is the total number of items visited by the user.

In another aspect of the present invention, an electronic data processing system for recommending articles and products to a user is disclosed. The system comprises: (a) an article information receiver module, for receiving content of an article; (b) a correlation module for creating a frequency occurrence vector in relation to the article content; (c) a product information receiver module for receiving intermediate data in relation to each of one or more products; (d) said correlation module creating intermediate data vectors in relation to each of the products from the intermediate data; (e) said correlation module comparing the frequency occurrence vector to the intermediate data vectors to determine a content similarity measure between the frequency occurrence vector and each of the intermediate data vectors; and, (f) a multiplexer module for providing a list comprising the article and the one or more products associated with the intermediate data vectors having the highest content similarity measure to the frequency occurrence vector. In one embodiment, the correlation module also determines a correlation measure between the article and the one or more products and wherein the list comprises one or more products having the highest correlation measure. In a more particular embodiment, the correlation measure is determined by a co-visitation approach.

In a further embodiment of the present invention, an electronic data processing system for recommending articles and products to a user is disclosed wherein the list provided by the multiplexer module also comprises popular articles as determined by click-through data captured by a user recommendation electronic widget.

### BRIEF DESCRIPTION OF THE DRAWINGS

The present invention will be more readily understood from the following detailed description when read in conjunction with the accompanying drawings, in which:

FIG. 1 shows a user interface in accordance with an embodiment of the present invention;

FIG. 2 shows a flow chart in accordance with an embodiment of the present invention; and

FIG. 3 shows a block diagram in accordance with an embodiment of the present invention;

FIG. 4 shows a schematic computer system in accordance with an embodiment of the present invention;

FIG. 5 shows a block diagram of a computer system in accordance with an embodiment of the present invention;

FIG. 6 is a screenshot showing a user interface in accordance with an alternative embodiment of the present invention, in grid view;

FIG. 7 is a screenshot of the user interface of FIG. 6, in expanded grid view;

FIG. 8 is a screenshot of the user interface of FIG. 6, in text view;

FIG. 9 is a screenshot of the user interface of FIG. 6, in expanded text view;

FIG. 10 is a screenshot showing a user interface in accordance with a further alternative embodiment of the present invention, in list view;

FIG. 11 is a screenshot of the user interface of FIG. 10, in grid view;

FIG. 12 is a screenshot of the user interface of FIG. 10, with a filter panel shown;

FIG. 13 shows a flow chart in accordance with an alternative embodiment of the present invention;

FIG. 14 shows a block diagram in accordance with the system provided by the present invention;

FIG. 15 provides a flow chart in accordance with an embodiment of the present invention;

FIG. 16 provides a flow chart in accordance with an embodiment of the present invention.

### DETAILED DESCRIPTION

It is a goal of the present invention to provide one or more of the following features or benefits:
(a) promote engagement by the user, indicated for example, by the user spending more time on web-site pages, the user viewing more pages, or the user reading more of an article;
(b) promote increased acceptance of the recommender system;
(c) provide a recommender system that is more enjoyable and fun for the user;
(d) provide a recommender system that increases page-views of articles by users;
(e) recommends to users more items that they like, and less of the ones that they don't like;
(f) provide a recommender system that increases the time spent by users viewing items;
(g) recommends to users third party products and services that a user may be interested in purchasing;
(h) provide a recommender system that increases the likelihood that a user will purchase third party products and services that are recommended;
(i) provide publishers and vendors with revenue arising from a user's impulse to buy at the “point of purchase” (e.g. when reading articles on the Internet);
(j) provide a recommender system that allows users to consume content and advertisements or offerings for products and services at the same time, or to consume offerings for products and services separately;
(k) provide a bridge between publishers or sources of content and online vendors to facilitate e-commerce for users who are interested in articles provided by publishers and products provided by vendors; and
(l) provide technology which permits vendors to offer customized information regarding their products in a way that each product is matched to related content and shown to the users who are consuming the related content.

As used in this application, the terms “step”, “module”, “component”, “model”, “system”, and the like are intended to refer to a computer-related entity, either hardware, a combination of hardware and software, software, or software in execution. For example, a module may be, but is not limited to being, a process running on a processor (CPU), a processor, an object, an executable, a thread of execution, a program, and/or a computer. By way of illustration, both an application running on a server and the server can be a module. One or more modules may reside within a process and/or thread of execution and a module may be localized on one computer and/or distributed between two or more computers. Also, these modules can execute from various computer readable media having various data structures stored thereon. The modules may communicate via local and/or remote processes such as in accordance with a signal having one or more data packets (e.g., data from one module interacting with another module in a local system, distributed system, and/or across a network such as the Internet with other systems via the signal). The processor (CPU) is the portion of a computer system that carries out the instructions of a computer program, and is the primary element carrying out the computer's functions.

The present invention is directed to an electronic data processing system for recommending items to a user and to a method of recommending items to a user.

The electronic data processing system for recommending items to a user and the method of recommending items to a user is suited for any computation environment. It may run in the background of a general purpose computer. In one aspect, it has CLI (command line interface), however, it could also be implemented with a GUI (graphical user interface) or together with the operation of a web browser or other application (or mobile “app”).

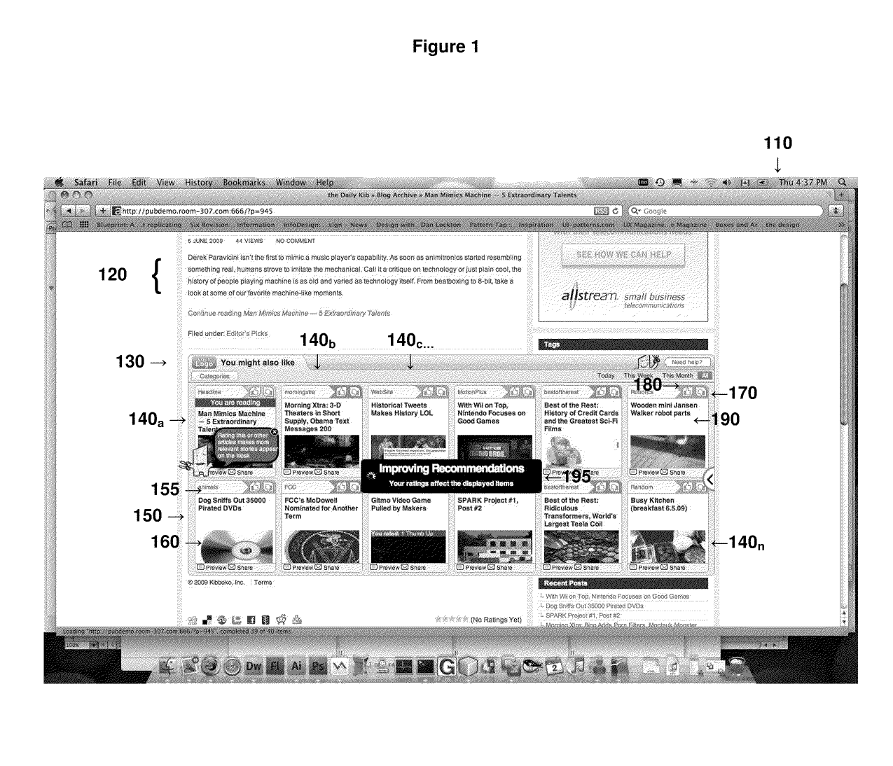

In an embodiment of the present invention, as is shown in FIG. 1, a user (not shown) views a display 110. The display 110, in an embodiment, shows an article or portion of an article currently being read, viewed or listened to 120. Also shown is a user recommendation electronic widget 130. User recommendation electronic widget 130 provides or displays information about one or more items, such as for example articles 140a . . . 140n that may be of interest to the user. In an embodiment, the first article, 140a, is the current article 120. The information (also referred to as data items) about articles 140a . . . 140n may include a title 150, an image 160, or further text relating to the article (not shown). Associated with each article 140a . . . 140n may also be a label 155 which provides a category of the related article, such as “animals”, “current events”, “news”, “sports”, or provides further information about the article. Associated with each article 140a . . . 140n may be an on-line button 170 to facilitate receiving user input on the displayed article 140a . . . 140n. With reference to FIG. 7, associated with each article 140a . . . 140n may also be a share button 154 to facilitate sharing the article by email or via another web service. As is shown in FIG. 1, on-line button 170 comprises, in an embodiment, a thumbs-up icon 180 and thumbs-down icon 190. By clicking on the thumbs-up icon 180 the user signals that they are favourably disposed towards the related article. Similarly, by clicking on the thumbs-down icon 190, the user signals that they are not favourably disposed towards the related article. Use of the term “signal” encompasses any user gesture or input that may indicate possible interest or disinterest in an item. User recommendation electronic widget 130 may also contain a region 195 for display of further messages to the user. Alternatively, these further messages may be overlaid over the information about articles 140a . . . 140n.

It has been discovered that user engagement may be increased if more articles are presented to the user. As such, there is a need to allow the user to view more articles 140a . . . 140n on the display 130 via the user recommendation electronic widget 130. However, the display 110 or user recommendation electronic widget 130 (or both) typically have size restrictions, and as such, there is a trade-off as to the number of articles 140a . . . 140n that may be presented versus the information about articles 140a . . . 140n that may be presented to the user.

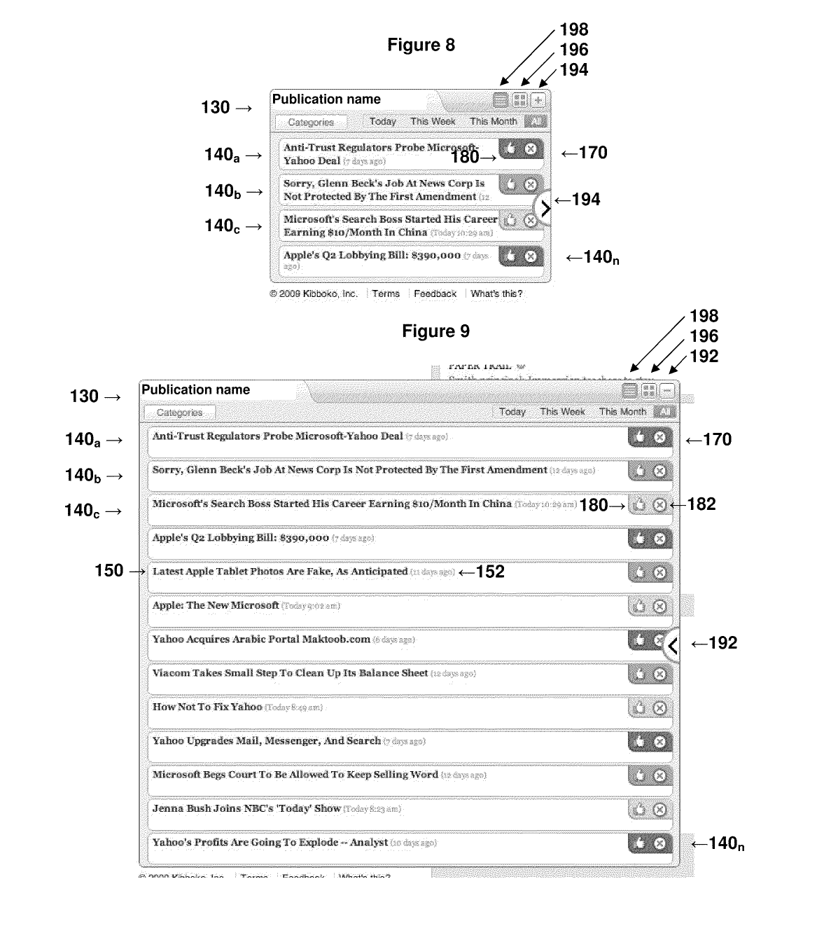

In respect of this embodiment of the invention, it has been discovered that some content is more suited for either a “grid view” presentation (as shown in FIG. 1, 6 or 7) or a “text view” presentation (as shown in FIG. 8 or 9). As described in the following paragraphs, although the “grid view” presentation is informative, the “text view” presentation which presents a list with a greater number of recommended articles may lead to better user satisfaction, usage, likelihood of accessing articles, etc.

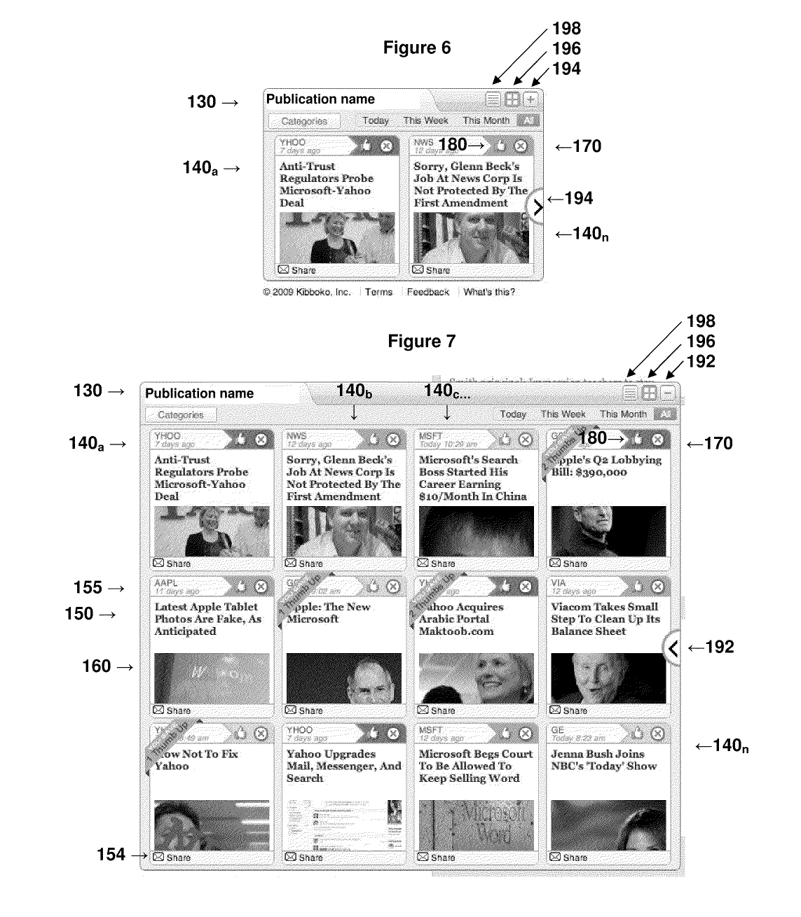

According to one aspect of the present invention, and as shown in FIGS. 6 and 7, the user recommendation electronic widget 130 is shown as having a “grid view” presentation. The “grid view” presentation may be suitable for articles or content that consists of an image, that includes an image or that can be represented with an image.

One or more maximize buttons 194 may be provided to increase the working area of the user recommendation electronic widget 130 (the expanded and unexpanded views are shown in FIGS. 6 and 8, and 7 and 9, respectively). The expanded (FIGS. 6 and 8) and unexpanded (FIGS. 7 and 9) views are an additional feature to overcome the problem of display and widget space limitations. One or more corresponding minimize buttons may be provided to reduce the working area of the user recommendation electronic widget 130.

Optionally, a grid view button 196 and a text view button 198 may be provided to permit the user to select from either a “grid view” presentation or a “text view” presentation, which is described in more detail below.

According to another aspect of the present invention, and as shown in FIGS. 8 and 9, the user recommendation electronic widget 130 is shown as having a “text view” presentation. Such a view gives the user recommendation electronic widget 130 an alternative presentation that may better suit the nature of certain articles or content. For example, publications such as the New York Review of Books, the New Yorker or Foreign Affairs have relatively few images associated with the text of each article. As shown in FIGS. 8 and 9, the information about such articles 140a . . . 140n may include a title 150, a date 152 (or an article age, etc.), or further text relating to the article (not shown). Moreover, the information may also include a small image, for example, a thumbnail image (not shown). Optionally, the user may click on or hover on the thumbnail image to see a larger image (not shown). Associated with each article 140a . . . 140n may be an on-line button 170 to facilitate receiving user input on the displayed article 140a . . . 140n. As is shown in FIGS. 8 and 9, on-line button 170 comprises, in an embodiment, a thumbs-up icon 180 and a close icon 182. By clicking on the thumbs-up icon 180 the user signals that they are favourably disposed towards the related article. Similarly, by clicking on the close icon 182, the user signals that they are not favourably disposed towards the related article. User recommendation electronic widget 130 may also contain a region 195 for display of further messages to the user. Alternatively, these further messages may be overlaid over the information about articles 140a . . . 140n.

Although two types of presentations have been described in considerable detail, namely the “grid view” and “text view” presentations, the skilled reader will appreciate that other types of views fall within the scope of this patent. For example, additional views could include but are not limited to, showing just a thumbnail images (image view), showing additional details such as an article summary (detailed view), showing a flip style view (coverflow view), showing article titles with varying sizes depending on which ones are recommended the most (cloud view). If additional presentation views are available, then the skilled reader will appreciate that user interface elements such as toggles, sliders, or buttons may be used to select a current view or cycle between the views, etc.

Still with reference to FIGS. 6-9, a further feature of the invention is to give publishers who may host the user recommendation electronic widget 130 the option of selecting a default view for the presentation (not shown) Moreover, the user recommendation electronic widget 130 may include a “memory” to remember the preference of the user for the default view, which may be stored as a cookie on the user's computer system.

The information about articles 140a . . . 140n is stored in a database. A subset (e.g. selected portions) of the information is displayed according to default view, or the view selected (e.g. as selected by the buttons 196 or 198). The selected or default view is stored as a variable (not shown). The variable determines which view mode the current displayed articles (or items) have, and renders each article according to that view mode. When the user recommendation electronic widget 130 first loads, the variable is populated by the default view mode that is set for all articles. If the user changes the view mode, then the variable may be overwritten by the newly selected mode.

The user recommendation electronic widget 130 evaluates whether the selected view (e.g. whether it is a “grid view” according to button 196 or “text view” according to button 198), accesses the database to query the portion of information that should be displayed and then sends the result of the query data to display the portion of information on the selected view.

Articles 140a . . . 140n may comprise articles that are frequently viewed, listened to or read. They may also comprise articles that are new or more recent. In an embodiment, the user may apply one or more filters (via a user interface which is not shown). These filters could select categories of articles a user is interested in, for example, only sports-related articles or no sports-related articles.

An important aspect of the present invention is that upon receiving input from the user on one or more of articles 140a to 140n the system and method, in the same session, provides one or more new (refreshed or replacement) articles to the user in place of one or more articles 140a to 140n. For example, in an embodiment, where a user gives a thumbs-up to one or more of articles 140a to 140n, the system and method will replace one or more articles 140a to 140n with a new article based on this user input. Similarly, in an embodiment, where a user gives a thumbs-down to one or more of articles 140a to 140n, the system and method will replace one or more of articles 140a to 140n with a new article based on this user input. In an embodiment, where the user gives a thumbs-up, one or more replacement articles are provided which are similar to the article given the thumbs-up.

Where an article is given a thumbs-down, one or more replacement articles are provided which are similar to an article previously given a thumbs-up. In an embodiment, after an article is rated (given a thumbs-up or thumbs-down), it remains displayed until the user clicks on a related button or icon containing text such as “show another article”.

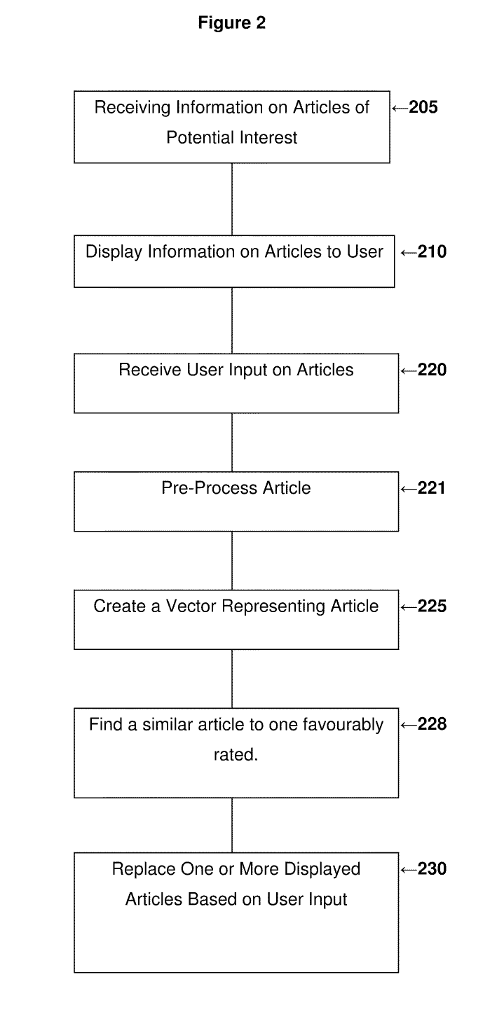

FIG. 2 provides a flow chart showing an embodiment of the present invention.

In step 205, information is received regarding articles of possible interest.

In step 210, information on articles of possible interest is displayed to a user.

In step 220, input is received from the user on one or more of the displayed articles. In an embodiment of the present invention, this input is a click (via a mouse or other input device) on a thumbs-up or thumbs-down icon.

In step 230, one or more of the displayed articles (or information about them) is replaced, based on the user input. Typically, a new article or articles would be provided.

As mentioned above, in an embodiment, when a user provides a thumbs-up, one or more similar articles are provided in user recommendation electronic widget 130. These replace articles originally displayed in widget 130. In an embodiment, a portion of articles 140a to 140n are used for this purpose.

The article receiving the thumbs-up may optionally be pre-processed in step 221. The data pre-processing 221 may comprise stop-word deletion, stemming and title and link extraction, which transforms or presents each article as a document vector in a bag-of-words data structure. With stop-word deletion, selected “stop” words (i.e. words such an “an”, “the”, “they” that are very frequent and do not have discriminating power) are excluded. The list of stop-words can be customized. Stemming converts words to the root form, in order to define words that are in the same context with the same term and consequently to reduce dimensionality. Such words may be stemmed by using Porter's Stemming Algorithm but other stemming algorithms could also be used. Text in links and titles from web pages can also be extracted and included in a document vector.

For each document, in step 225 of the invention a vector is created, setting out the frequency of occurrence of each of the words found in the article. In other words for each article of interest a vector is created {F1, F2, . . . FX}, where F1 represents the frequency in the document of the word, W1. Where a word is not found in the article, the frequency is zero.

In another embodiment, the vector may only be created for a portion of the article, such as the title and first paragraph, or for a brief description or abstract of it.

Vectors are then created using the same words, to represent other potentially similar articles. Then the vectors are compared in step 228 to determine those most similar. In an embodiment, a cosine similarity measure may be used to compare the two article vectors.

For example:

$$\begin{matrix}Article 1 words \text{:} & {W}_{1} , & {W}_{2} , & {W}_{3} , & {W}_{4} … & {W}_{n} \\ \# of occurrences & 6 , & 3 , & 2 , & 1 , … & 1 \\ & & & & & \\ Article 2 \# of & 3 , & 0 , & 1 , & 0 , … & 0 \\ occurrences & & & & & \end{matrix}$$

$$Similarity = \frac{\begin{matrix}\sum \# of occurrences {W}_{n} in article 1 \times \\ \# of occurrences of {W}_{n} in article 2\end{matrix}}{\sqrt{{W}_{n}^{2} in Article 1} \times \sqrt{{W}_{n}^{2} in Article 2}}$$

For example:

$$Similarity = \frac{6 \cdot 3 + 3 \cdot 0 + 2 \cdot 1 + 1 \cdot 0 … + 1 \cdot 0}{\sqrt{{6}^{2} + {3}^{2} + {2}^{2} + {1}^{2} … {1}^{2}} \cdot \sqrt{{3}^{2} + {0}^{2} + {1}^{2} + {0}^{2} … {0}^{2}}}$$

Other measures of similarity are also possible for example:
(a) Sørensen's quotient of similarity
(b) Mountford's index of similarity
(c) Hamming distance
(d) Dice's coefficient
(e) Jaccard index
(f) SimRank
(g) Weighted cosine measure

In another embodiment, the publisher of articles, such as a newspaper publisher, provides the information which is received in step 205. In another embodiment, this is provided via an extension to the RSS feed version 2.0. For each article, the publisher may provide the following information:
(a) article title;
(b) author;
(c) article URL;
(d) article text;
(e) article category;
(f) the URL of a thumbnail image;
(g) article ID; and,
(h) a final date of publication.

In another embodiment, articles (or information about them) are not displayed after the final date of publication received from the publisher.

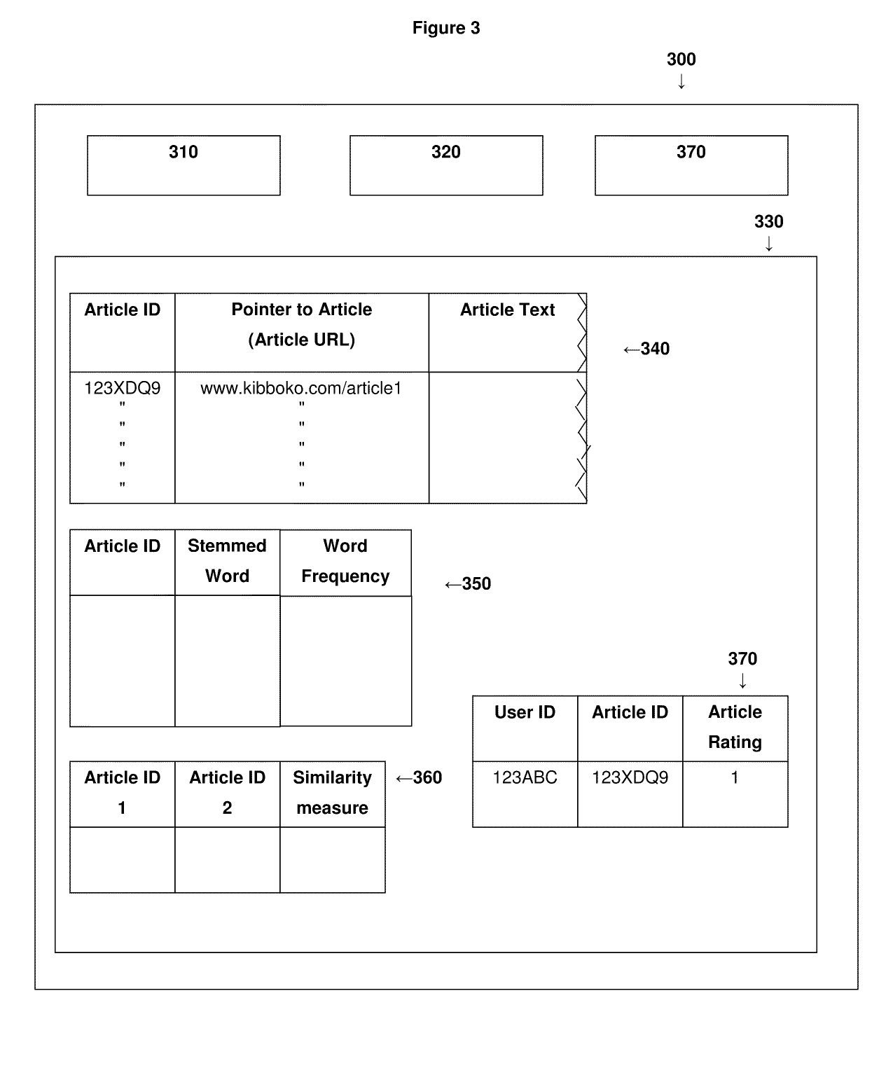

Further information on the RSS specification can be found at http://cyber.law.harvard.edu/rss/rss.html. In another embodiment, the information from this RSS feed is stored on table 340 as partially shown in FIG. 3. Alternatively, this information can be received in various other ways, including via spreadsheets or can be acquired by web robots.

In another embodiment, related to each article is a table, stored in a database, which stores stemmed words and the associated word count for each article. This is shown in FIG. 3.

FIG. 3 shows a recommender system 300, which contains a display 310 and user input device 320. Recommender system 300 also contains a database 330 with a number of tables, such as table 340 which is described above. Database 330 also contains table 350 which provides for each article ID, a list of stemmed words and the frequency each stemmed word appears in the article identified word.

In another embodiment, each user is given a unique user ID, which is stored as a cookie on the user's computer system. Database 330 also contains a table 370, which sets out information such as the user ID, article ID, and the input or rating received on the article.

In another embodiment, database 330 also contains a table which stores the IDs for first and second articles and the associated similarity measure.

The format of tables described as occurring in database 330 are exemplary only—other formats are possible and within the scope of the present invention.

Recommender system 300 also contains a CPU 370 for calculating similarity measures and for carrying out other tasks.

When a user gives one or more of articles 140ₐ . . . 140ₙ a less favourable rating, for example, a thumbs-down, the system then checks table 370 and determines a previous article given a more favourable rating. One or more articles (or information about them) similar to a previously favourably rated article is then displayed to the user. The displayed articles will be ones meeting a specified criteria. The most similar article or articles may be displayed as replacement articles. Alternatively, articles exceeding a threshold level of the similarity metric may be displayed.

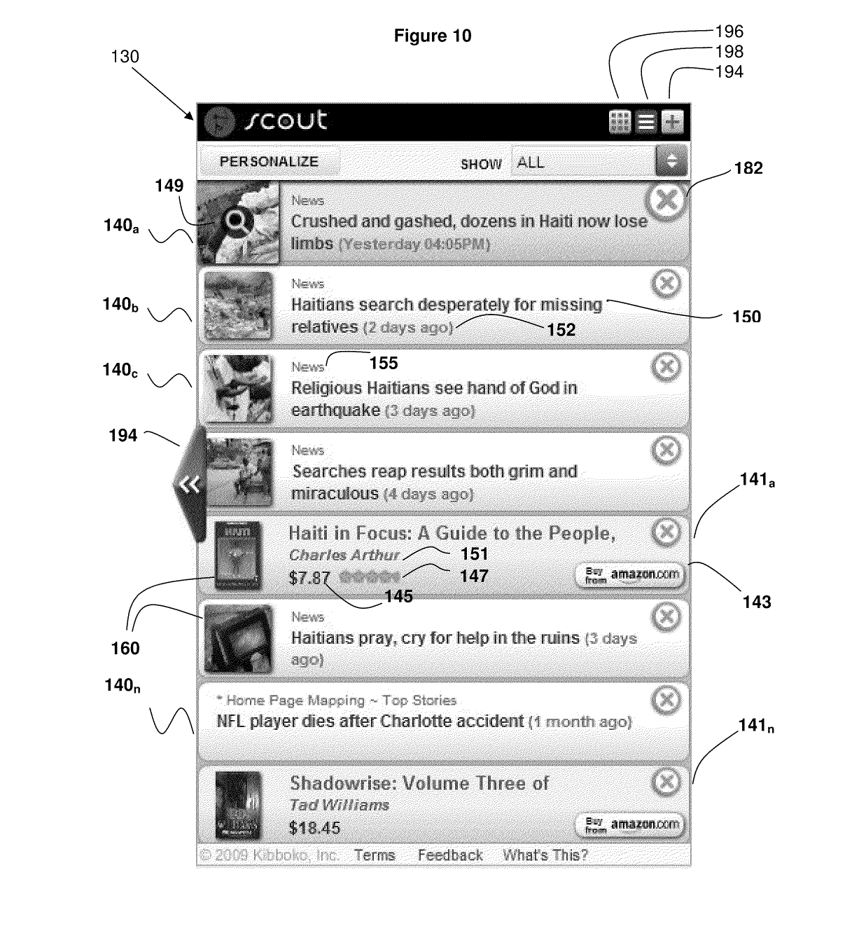

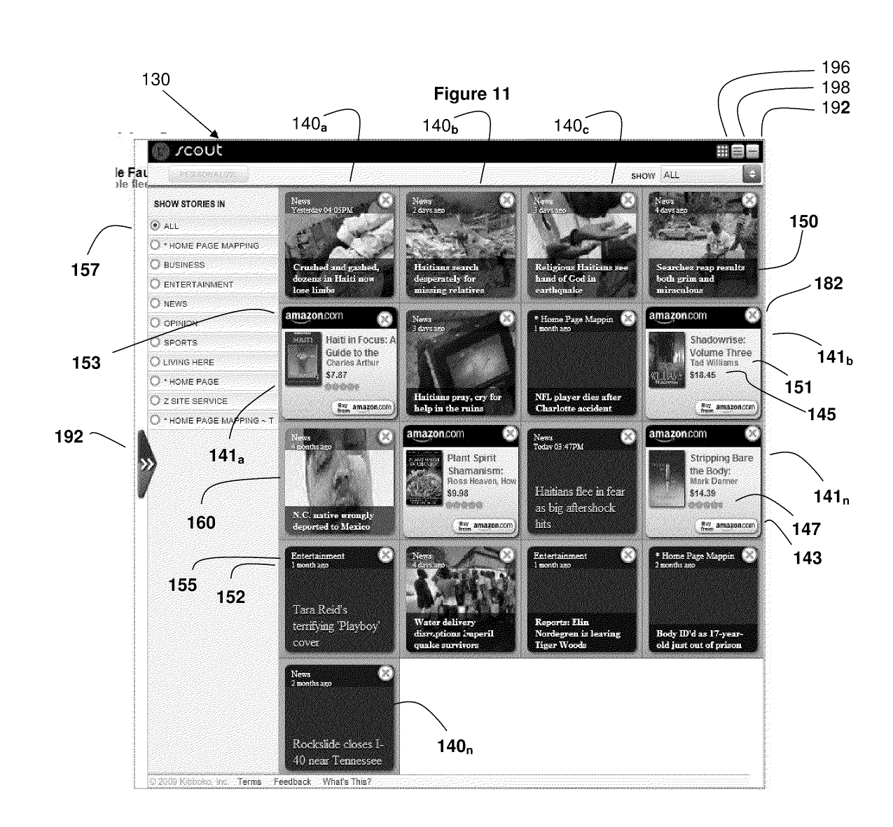

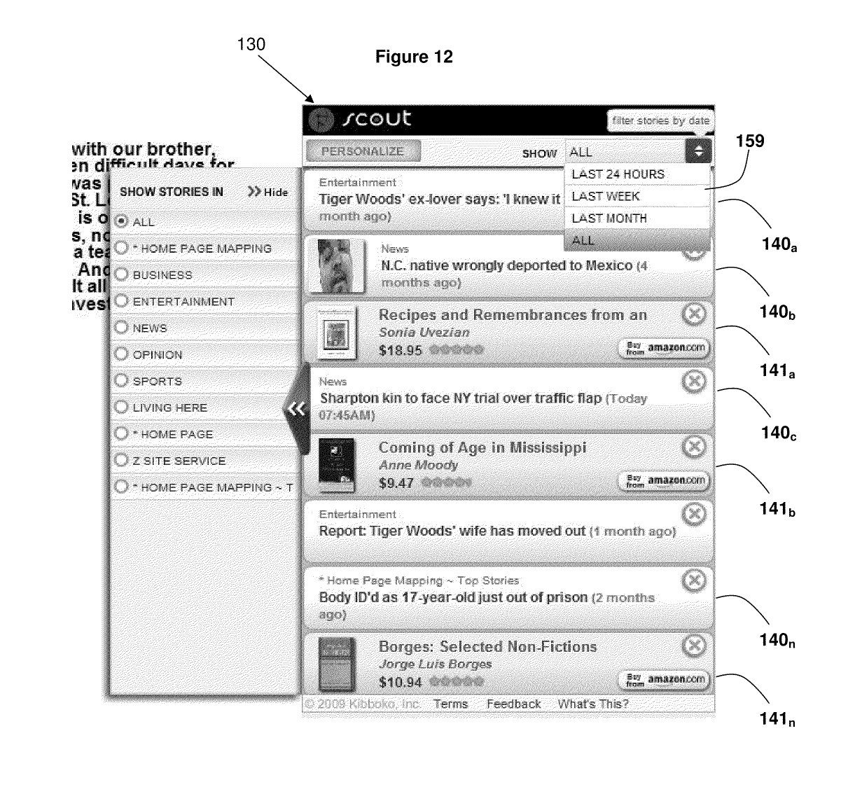

Turning now to FIGS. 10-12, further alternative embodiments of the user recommendation electronic widget 130 are shown. In FIGS. 10 and 12, the user recommendation electronic widget 130 is shown with a text view presentation. In FIG. 11, the user recommendation electronic widget 130 is shown with a grid view presentation. The user recommendation electronic widget 130 may be displayed on the website of a publisher, for example, on one or more pages of an online newspaper, accompanying the articles. The user recommendation electronic widget 130 could alternatively be displayed on the website of a vendor. As a further alternative, the user recommendation electronic widget 130 may be displayed on any webpage, website or mobile app. The user recommendation electronic widget 130 may also display articles from a plurality of different publishers.

As with the previously mentioned embodiments, user recommendation electronic widget 130 may provide or display information about one or more items such as articles 140ₐ . . . 140ₙ that may be of interest to the user. In the embodiment shown in FIGS. 10 and 12, each article has a title 150 and may be associated with a category label 155 and an age 152 which, as above, provides a category and an age (or time since initial publication) of the related article, respectively. For example, in FIG. 10, for article 140b, title 150 is “Haitians search desperately for missing relatives”; age 152 is “2 days ago”. In FIG. 10 and article 140c the category label 155 is “news.” In this embodiment, each of the one or more articles 140ₐ . . . 140ₙ may be associated with an image 160. A zoom icon 149 may be presented to prompt the user to click and see a larger image (not shown). An age filter 159 (shown in FIG. 12) may be provided so that the user may, for example, view just articles posted in the last 24 hours, posted in the last week, posted last month, or all articles. A category filter 157 (shown in FIG. 11) may be provided to select categories of articles a user is interested in, for example, only sports-related articles or no sports-related articles. In a preferred embodiment of the present invention a user may select either “all” categories, or one from a list of categories. An embodiment of the user recommendation electronic widget 130 may employ user interface prompts such as enlarging or highlighting clickable elements (not shown).

An important aspect of the embodiments of FIGS. 10-12 is that the user recommendation electronic widget 130 may recommend third party products or services from one or more vendors that the user might be interested in purchasing. In one embodiment of the invention, information about third party products or services may be displayed in a user recommendation electronic widget 130 dedicated to displaying products and services (not shown).

In another embodiment, the recommended products or services may be displayed in addition to recommended on-line content from one or more publishers. According to this embodiment, information about third party products or services may be displayed along with the information about articles in the user recommendation electronic widget 130. For example, if a user was reading an article about US national politics, then the user recommendation electronic widget 130 may display to them information about Sarah Palin's book Going Rogue or about David Plouffe's book, and then offer links to facilitate a purchase. Referring to FIG. 11, where one or more news articles about an earthquake in Haiti are recommended to the user, then user recommendation electronic widget 130 may also recommend to the user a book about Haiti which can be purchased by the user, shown as information about product 141a.

A participating vendor may offer referral fees and provide a tag to identify the source of the referral. The tag may be included in a request sent to the vendor when the user is sent to or links to the vendor's site in order to track referrals made from the user recommendation electronic widget 130 which may be necessary or facilitate referral fees paid by the vendor to the provider of the user recommendation electronic widget 130.

The information displayed about an article will typically be different than the information displayed about a product in the user recommendation electronic widget 130. For a product, the information capable of being displayed (also referred to as data items) about one or more products 141ₐ . . . 141ₙ may be different. As shown in FIGS. 10-12, if the products 141ₐ . . . 141ₙ are books offered for purchase by a third party online book vendor, for example, but not limited to, Amazon™, then the corresponding data items to such a product may comprise one or more of a title 150, an author 151, a price 145, a rating 147. The data items may also contain some means to purchase the product, such as providing a link to the third party vendor 143. For example, in FIG. 10 link 143 is a link to amazon.com. The system of the present invention is not limited to books, or to a single type of product or service. For example, the products 141ₐ . . . 141ₙ may also comprise music tracks offered by a third party online music vendor where the data items comprise a track title, an album title, a performer, a rating, a measure of popularity, etc. (not shown). The products 141ₐ . . . 141ₙ may also be mobile apps or some other physical or digital goods, or could also be services available via the vendor. The data items provided may depend on data items available in an on-line catalogue of the vendor. In an alternative embodiment, other sources of data may be extracted to provide data items in relation to the products. For example, data items may include product reviews published by parties other than the vendor.

In the embodiments shown in FIGS. 10-12, an on-line button 170 comprises a close icon 182. By clicking on the close icon 182, the user signals that they do not wish to have that article displayed on user recommendation electronic widget 130, perhaps because they are not favourably disposed towards the related article or product. By contrast, the user may signal that they are favourably disposed towards the related article or product by clicking on one of the article's data items (e.g. title 150) and causing the article to load in the display 110 or, in the case of a product, causing an e-commerce facility to be loaded to facilitate the purchase of the product, respectively. An example of an ecommerce facility would be one or more online screens, provided by a vendor or publisher, that permitted purchase of the product in question, or a display button, which, when clicked, facilitated purchase of the product. In this regard, different purchase fulfillment interfaces (online screens or display buttons, and associated technology) may be provided for different product or service vendors. When a user loads the ecommerce facility, this may also include a transmission of data from the system of the current invention to the vendor or publisher, identifying the source of the origination of the user. This may facilitate participation in affiliate programs of the vendor or publisher, by which the provider of the present invention is paid a commission or fee on sales of the products.

If an article or product is closed after the user clicks the close icon 182, then one or more replacement articles or products may be provided which are similar to an article previously favourably rated. In an embodiment of the invention, a queue or list of articles to be recommended is created. However, the user recommendation electronic widget 130 may not have space or room to display all the items in the queue or list. In this embodiment of the invention, the one or more replacement articles or products are the next highest ranked article or product from the queue or list that has not yet been displayed. Both the products or services available from vendor(s) and the articles from the publisher(s) may vary and update continuously, according to one of a number of approaches which correlate articles read to products or services recommended, as described in more detail below.

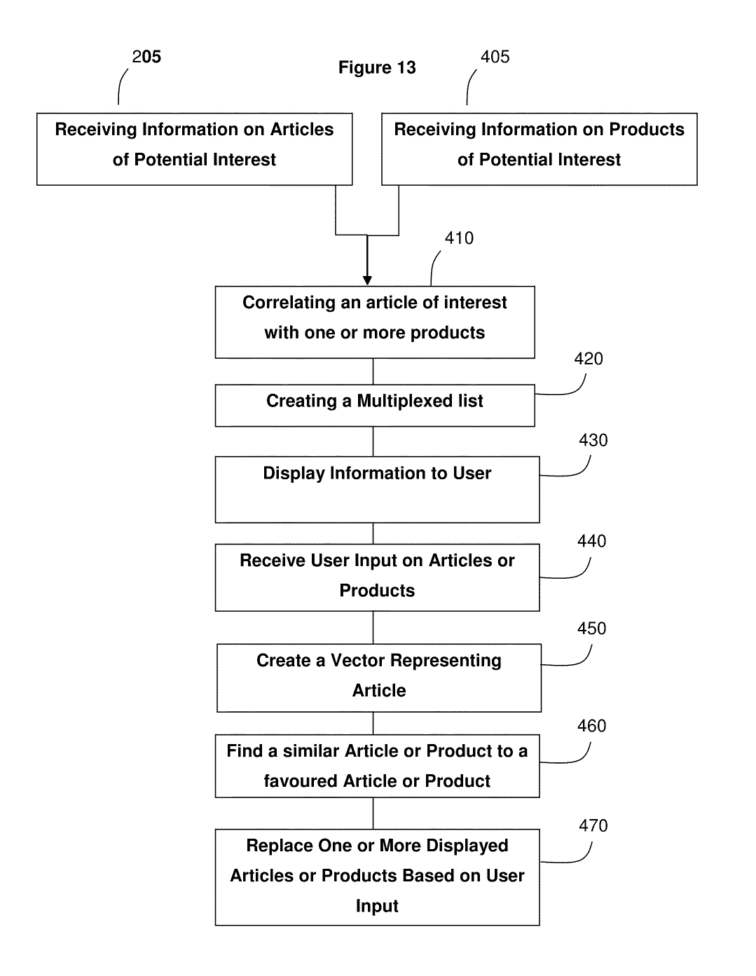

FIG. 13 provides a flow chart showing an alternative embodiment of the present invention.

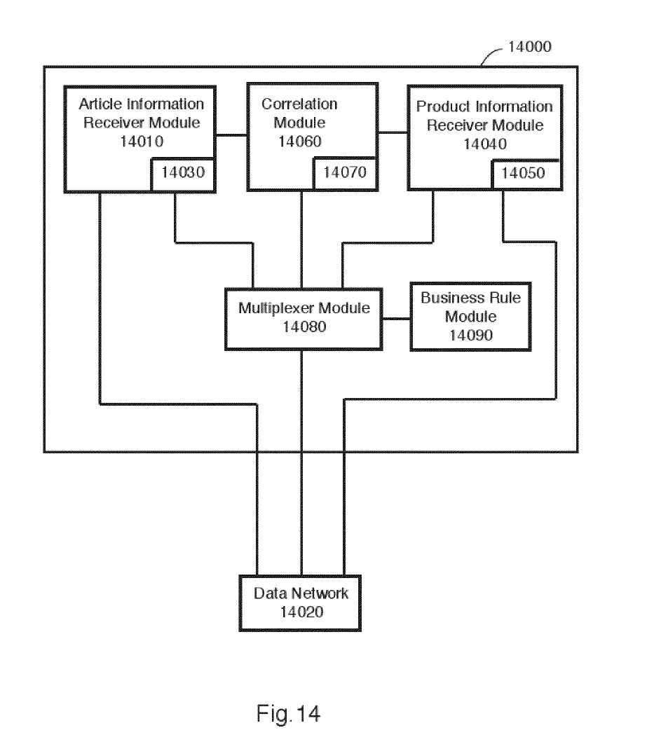

In step 205, information is received from one or more publishers regarding articles of possible interest. Alternatively, content may be obtained from crawling web-sites available via the internet. As is further illustrated in FIG. 14, information is received in article information receiver module 14010, which is part of computer system 14000 of the present invention. Article information receiver module 14010, is operatively coupled to a data network 14020. The information is received via data network 14020. Article information receiver module 14010 contains a database 14030 which stores a list of articles, together with data associated with such articles, such as the title, category, age, etc. In a preferred embodiment the list of articles is continuously updated, with articles being added, updated, or removed from time to time. System 14000 may crawl for articles to determine which articles have gone offline (i.e., to verify whether articles are still accessible). Where an article is determined to have gone off-line it will no longer be presented to a user. In an embodiment of the invention, publishers seeding the recommendation system with articles can choose which vendors to work with (and vice versa). Step 205 is optional and may not be required where the system is dedicated to recommending products or services.

The publisher of articles, such as a newspaper publisher, provides the information which is received in step 205. In another embodiment, this is provided via an extension to an RSS feed version 2.0. For each article, the publisher may provide the following information:
(a) article title;
(b) author
(c) article URL;
(d) article text;
(e) article category;
(f) the URL of a thumbnail image;
(g) article ID; and,
(h) a final date of publication.

In another embodiment, articles (or information about them) are not displayed after the final date of publication received from the publisher.

Further information on the RSS specification can be found at http://cyber.law.harvard.edu/rss/rss.html. The World Wide Web Consortium (W3C) has published an RSS specification which can be found at http://validator.w3.org/feed/docs/rss2.html.

In step 405, information is received regarding products of possible interest. As is further illustrated in FIG. 14, information is received in product information receiver module 14040, which is part of computer system 14000 of the present invention. Article information receiver module 14040, is operatively coupled to a data network 14020. The information is received via data network 14020. Product information receiver module 14040 contains a database 14050 which stores a list of products, together with data associated with such products, such as the price, link to the vendor, rating, description, etc. Associated with the product will be intermediate data, such as a product description or product reviews, which describe in a meaningful way the content or attributes of the product. The intermediate data about each product may be referred to as an intermediate data set. In a preferred embodiment the list of products is continuously updated, with products being added or removed from time to time. System 14000 may crawl for products to determine which articles have gone offline (i.e., to verify whether articles are still accessible). System 14000 may also crawl for product information to ensure that the data in relation to the product, for example price, is up to date. Where a product is determined to have gone off-line it will no longer be presented to a user.

For example, system 14000 may extract information through an online vendor's application public interface or API (e.g. Amazon's Product Advertising API gives access to its catalog of 20 million products). Different vendors may employ different APIs and, as is known to those skilled in the art, the API will have to be used differently in order to extract the desired information. A “tree walker” may periodically scan the vendor's categorization tree in which a product can appear in multiple tree nodes (categories) of the tree. The scan's frequency may be set to comply with the vendor's terms of service (e.g. at least once every 24 hours) or by a desire to have quite current information (e.g. where prices are quite volatile). The tree walker may “walk” the tree looking for popular products (or new products, etc.) in each category or in all categories (such as bestsellers). The tree walker may identify products that ought to be included in that category. Once popular products within each category are identified, descriptions or product attributes (such as price, average user rating, a link to the vendor, etc.) provided by the vendor or elsewhere may be downloaded or otherwise received. The system of the present invention is not restricted to an Amazon-type service; it may take any feed of data containing information about products for sale from any vendor. In this way, and as will be explained, a personalized/contextual advertisement can be provided for the vendor, provided that the vendor's catalog is, at least in part, available to provide data to the system.

The intermediate data associated with the product does not have to be provided, or provided solely by, the vendor of the product. It could also be provided by third parties. In this case, the system of the present invention would determine an association between the product and the third party intermediate data and then download the third party information via product receiver module 14040 for storage in database 14050, in association with that product.

In an embodiment of the invention, a location-based filter may be applied to include just products available in the jurisdiction of interest. For example, for products to be advertised among articles from a Canadian publisher targeting users from a particular city, a coarse-grain filter may be applied to include products for sale in that jurisdiction but not elsewhere. Sometimes, however, a local publication with a major local presence will target a global audience, and may not require such filtering. In an embodiment of the present invention, the user's IP address is employed in a way known to those skilled in the art to determine or estimate the user's geographical location. This geographical location can be interpreted by the location-based filter as is set out above.

An important feature of the recommendation system of the present invention is that a “description-based” correlation can be made between the items (be they products or articles) such as, for example, the content of articles found in database 14030 and the intermediate data, such as a product description, associated with each of the products found on database 14050 (in FIG. 14). In one embodiment of the present invention, the system 14000 takes intermediate data such as a description (e.g. catalog description and/or the publisher's review) of a product (e.g. a book) from a vendor such as Amazon and correlates this intermediate data with the content of a news article. For many products on the Internet, online vendors such as Amazon provide useful written descriptions which may serve as the intermediate data. Further, Amazon and other vendors may publish lists of popular products within categories such as current events, sports, or cooking which may be accessed to provide the product content for the user recommendation electronic widget 130. It is observed that obtaining product attributes in certain domains is more difficult than for others. For example, the content of music and feature films is difficult to analyze. In these circumstances, intermediate data such as music or film reviews may be used.

This correlation between items is carried out in correlation module 14060 shown in FIG. 14. Correlation module 14060 will produce a list of one or more items (e.g. products) that are most similar to an item (e.g. an article) of interest.

As is shown in FIGS. 10 and 11, in one embodiment of the invention one or more articles are recommended to the user. In this embodiment, an aggregated list of recommended items (articles, products, or both) are produced in accordance with the method set out in the flow chart shown in FIG. 16.

In step 17010 of FIG. 16, a list of one or more products is generated that are most similar to a given item. The generation of this list is described in more detail below. This step is repeated for each recommended item (e.g. article), providing a separate list of recommended items (e.g. products). In a preferred embodiment, the list of recommended items only contains recommended products.

In step 17020, weighting factors are applied to the items on each list. For example, more weight may be given to products associated with a more recent article.

In step 17030, the lists are combined using the weighting factors.

In step 17040, those products in the combined list with the highest aggregate weighting factors are presented to the user. For example, a number of scored lists of products may be generated for each article, according to one or more approaches described below (content similarity, personal co-visitation, item co-visitation, new items, popular items, business logic, etc.). When the user recommendation electronic widget 130 is to generate a new recommendation for a user, these lists may be consulted for the last n items the user has viewed including the current item. These lists may be combined by weighting scores according to position in the history. If a product appears in multiple lists, its scores may be added together. The result is a single combined list ranked by the weighted scores. These steps 17010-17040 may be carried out in a background or off-line process, with the single combined list ranked by the weighted scores being generated on a periodic basis, for example, in a preferred embodiment, daily.

As is seen in the flow chart in FIG. 13, in step 410 an article of interest may be correlated with products found in database 14050 of FIG. 14. According to an alternative embodiment of the present invention, the correlation of products to articles may also depend on additional information based on user behaviour. According to this embodiment, the user's behaviour may be calculated to determine, for example, whether the user closed the product recommendation or the article recommendation (or both), or read the recommended article and produce a history of the user's interests.

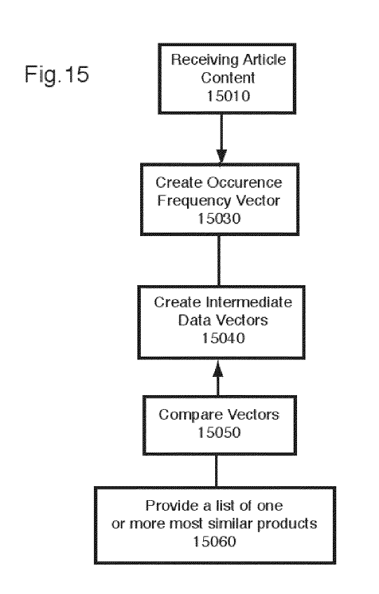

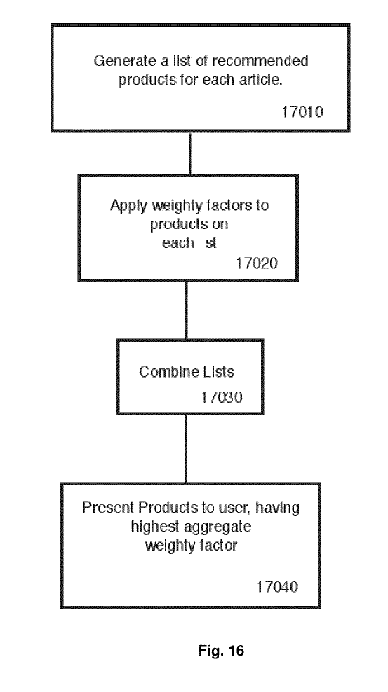

In step 410, the system correlates candidate items (e.g. products) and other items (e.g. articles) of interest. In one embodiment of the present invention, a content similarity approach is used to determine similarity (or correlation) between an article of interest (found in database 14030) and products of interest (described in database 14050). A tag cloud approach is an example of a content similarity approach. FIG. 15 provides a flow chart showing the steps of this approach. In step 15010 the correlation module receives the content of an article. In step 15030 of the invention a frequency occurrence vector is created, setting out the frequency of occurrence of each of the words found in the article. In other words for each article of interest a vector is created {F1, F2, . . . FX}, where F1 represents the frequency in the document of the word, W1. Where a word is not found in the article, the frequency is zero.

In step 15040, intermediate data vectors are then created using the same words (W1-WX), for each of the intermediate data which describes each of the products in database 14050. Then the article vector is compared in step 15050 to determine those products most similar to the article. In an embodiment, cosine similarity may be used to compare the two article vectors.

For example:

$$\begin{matrix}Article 1 words \text{:} & {W}_{1} , & {W}_{2} , & {W}_{3} , & {W}_{4} … & {W}_{n} \\ \# of occurrences & 6 , & 3 , & 2 , & 1 , … & 1 \\ & & & & & \\ Product 1 ( Intermediate Data ) & & & & & \\ \# of occurrences & 3 , & 0 , & 1 , & 0 , … & 0\end{matrix}$$

$$Similarity = \frac{\begin{matrix}\sum \# of occurrences {W}_{n} in article 1 \times \\ \# of occurrences of {W}_{n} in Intermediate Data of Product 1\end{matrix}}{\begin{matrix}\sqrt{{W}_{n}^{2} in Article 1} \times \\ \sqrt{{W}_{n}^{2} in Article 2} Intermediate Data of Product 1\end{matrix}}$$

For example:

$$Similarity = \frac{6 \cdot 3 + 3 \cdot 0 + 2 \cdot 1 + 1 \cdot 0 … + 1 \cdot 0}{\sqrt{{6}^{2} + {3}^{2} + {2}^{2} + {1}^{2} … {1}^{2}} \cdot \sqrt{{3}^{2} + {0}^{2} + {1}^{2} + {0}^{2} … {0}^{2}}}$$

Other measures of similarity are also possible for example:
(a) Sørensen's quotient of similarity
(b) Mountford's index of similarity
(c) Hamming distance
(d) Dice's coefficient
(e) Jaccard index
(f) Sim Rank
(g) Weighted cosine measure

In step 15060, one or more most similar products to the articles are stored or displayed. This correlation function is carried out in correlation module 14060 by a computer processor which makes the above calculations.

Besides the content similarity approach described above, another approach to obtain a correlation measure between two items is to use a co-visitation approach. Co-visitation is defined as an event in which two items (e.g. articles) are viewed or clicked by the same user within a certain time interval (typically set to a few hours). Imagine a graph whose nodes represent items and weighted edges represent the time discounted number of co-visitation instances. In other words, as more time elapses since the co-visitation has occurred, a lower weighting is provided. Alternatively, a lower weight could be allocated as the elapsed time increases between the visits comprising a co-visitation pair. The edges could be directional to capture the fact that one item was clicked after the other, or not if we do not care about the order. This graph may be maintained as an adjacency list that is keyed by the item id. On item sk, the user's recent click history Cui may be retrieved and iterated over the items in it. For all such items sj ε Cui, the adjacency lists are modified for both sj and sk to add an entry corresponding to the current click. If an entry for this pair already exists, an age discounted count is updated. Given an item s, its near neighbours are effectively the set of items that have been co-visited with it, weighted by the age discounted count of how often they were co-visited. This captures the following simple intuition: “user who viewed this item also viewed the following items”.

For a user ui, the co-visitation based correlation measure may be generated for a candidate item (e.g. article or product) s as follows: the user's recent click history Cu is fetched, limited to past few hours or days. For every item si in the user's click history, the entry for the pair si is looked up, s in the adjacency list for si stored in the adjacency list. To the correlation measure, the value stored in this entry is normalized by the sum of all entries of si is added. Finally, all the co-visitation scores are normalized to a value between 0 and 1 by linear scaling (for example, by dividing by the number of viewed articles).

An embodiment of the invention may employ a “item co-visitation” approach or a “personal co-visitation” approach (or both). The item co-visitation approach is a simpler case—the item ID(s) with the highest co-visitation value(s) are selected for recommendation. Personal co-visitation introduces more complexity. A further total views article table is maintained representing the total number of views for each article and a further calculation may be made: for each article in the viewing history, the co-visitation value from the co-visitation table is compared to the total number of views for that article. If the co-visitation value is high, but the total number of views is much larger, then the co-visitation value will be discounted accordingly. In other words, the total number of views is a weight that is applied to the co-visitation value to provide a more meaningful co-visitation value.

### Co-Visitation Example #1

Co-visitation table

| Item ID #1 | Item ID #2 | # of co-visits within given time interval |
|---|---|---|
| a | 2 | 11 |
| a | 3 | 100 |
| a | 4 | 50 |
| b | 2 | 30 |
| b | 3 | 70 |

Item total views table

| Item ID | unique visits |
|---|---|
| a | 100 |
| 3 | 350 |
| 2 | 50 |
| 4 | 1000 |
| b | 200 |

For each item viewed in the user's history, i ε viewed, the co-visitation count f is calculated (i.e., the count of how many unique users visited a pair of items or visited just one item) in respect of each possible candidate item (a candidate item could be an article or product), and this count is divided by the total number of viewed items to give a score:

$$\frac{{\sum }_{i ∈ viewed} \frac{f ( viewed , candidate )}{f ( viewed )}}{\# viewed}$$

### Co-Visitation Example #2

For example, to calculate the score for candidate item 2 for a user having user history a, b, . . . n, where each a, b, . . . n is an item viewed or displayed by the user) the score would be calculated as follows:

$$\frac{\frac{f ( a , 2 )}{f ( a )} + \frac{f ( b , 2 )}{f ( b )} + … + \frac{f ( n , 2 )}{f ( n )}}{n}$$

In the above example, n is the total number of items visited by other users who have also visited item 2. In an embodiment of the invention, it may be desirable to calculate candidate items that are products only, or products that are associated with an image only, for example, or other configurable parameters. Even where the candidate items are products only, the co-visitation algorithm may still use articles viewed as input.

The correlation measures for all candidate items are compared, and the candidate item(s) with the highest score(s) may be presented to the user or queued in a list for presentation to the user when display space on the user electronic recommendation widget 130 is available. Intuitively, the candidate item with the highest score represents the item where, given the user's viewing history, the user would be most likely to view the item if the user behaved in a similar manner to other users.

The co-visitation algorithm may be run on the server as a separate process on a periodic basis, e.g. once per day. This algorithm runs in O(users×candidate items×viewed items) computational time. In other words, on a periodic basis, based on an updated user history, a new list of candidate items to be recommended to the user is generated. This newly generated list depends on both the user's history as well as the behaviour of other users of the system. It is the behaviour of the other users of the system that provides the number of viewed items in paragraph [00113] above. The time interval may be set at 2 weeks. Where there are small number of articles, or where traffic to a site is small, it may be desirable to set a longer time interval in order to have more input to the co-visitation algorithm.

An alternative embodiment of the invention may be implemented to handle incremental correlation. For example, if an item description changes, then all previous correlations may be invalid and the system may require new correlation measures be generated. However, if the item description remains the same, then the system will only need to generate a correlation measure against new products (not all products).

Besides co-visitation, other approaches may be used to generate a correlation measure. For example, the “most popular” approach may refer to the “Item total views table” maintained by the co-visitation approach to select items popular among all users, excluding the articles viewed by the user in question. The item total views table is maintained by the provided of user recommendation electronic system 14000. This permits a determination of “most popular” that does not depend on extensive access to the publisher's website and click-stream.

In accordance with an aspect of the invention, it will be appreciated that the system may generate a correlation measure based on intermediate data. This intermediate data may be drawn from, among other things, the item itself (e.g. an article's content), from item descriptions (e.g. a product description, a movie review, etc.), or from user “opinions” (e.g. as determined by user ratings, click-through data, conversion data, etc.). It will be appreciated that click-through behaviour, as with other data, may be inputs to a cosine similarity algorithm (or some other similarity algorithm) to generate a correlation measure. If the system maintains the following table of user click-through data, where the number 1 represents a given user's interest in a given item (such as having clicked on an article or product), then these “opinions” may be used to generate a correlation measure:

| | User A | User B | User C | User D |
|---|---|---|---|---|
| Item R1 | 1 | 0 | 1 | 1 |
| Item R2 | 0 | 1 | 0 | 0 |

In step 420 (shown in FIG. 13), a multiplexed list of items (e.g. articles and products) is created. This is carried out in multiplexer module 14080 as shown in FIG. 14. For example, in step 420 information about articles from database 14030 and correlated products from database 14050 are multiplexed together and sent to user recommendation electronic widget 130. The multiplexer module combines (or mixes) one or more articles 140a . . . 140n with one or more 141a . . . 141n products. The products 141a . . . 141n are, in one embodiment of the invention, those having the most similar intermediate data to one or more articles 140a . . . 140n. In an embodiment of the invention, the multiplexer may present product recommendations from one or more vendors in a round-robin format.

Those products 141a . . . 141n having the highest correlation measures to articles 140a . . . 140n may be determined by selecting those products having the highest n correlation measures, where n is an integer. Alternatively, they may be determined by selecting those products having a correlation measure which exceeds an operator determined threshold.

In an embodiment of the invention, the multiplexer module 14080 may further present article recommendations from one or more algorithms in a round-robin format, the algorithms being selected from a plurality of approaches, such as the content similarity approach, the personal co-visitation approach, the product co-visitation approach, and the most popular approach. For example, the multiplexer module can take five algorithms and arrange the algorithms in a “batting order” such that four recommendations are selected from algorithm #1, then three recommendations are selected from algorithm #2, and so on. This is called a round-robin technique. Alternatively, “slots” in the user recommendation electronic widget 130 may be dedicated to a particular algorithm. The multiplexer module may be pre-configured to display a pre-defined number of products. The multiplexer module may be configured from business rule module 14090 so that, for example, the user recommendation electronic widget 130 does not present a screen where the top four articles are products, or where no products are presented. The business rule module 14090 may provide instructions to multiplexer module 14080 in respect of use of ordinal slots in the user recommendation electronic widget 130 (e.g. positions 3, 5 and 8 are reserved for products from Amazon, iTunes™, and LL Bean™, respectively). The multiplexer module 14080 may elevate or insert product information, rather than article information, depending on the vendor, publisher or other requirements as provided by business rule module 14090. In an embodiment of the invention, the multiplexer module 14080 may be located on a server and may be controlled by configurable parameters, including image present, algorithm list, recency, etc. of the multiplexer module 14080, which may be stored in an XML file stored on the server, permitting fast distribution of the business rules from business rule module 14090 without requiring re-publication of the client application (the user recommendation electronic widget 130).

Business rule module may also provide other rules for determining products to be recommended to an end user. For example, it could provide that one product be from a “bestseller” list. Or during a holiday season, it could provide that one or more products recommended be holiday-related.

In step 430 (shown in FIG. 13), information on articles and products of possible interest are displayed to a user. This information is transmitted from multiplexer module 14080 of system 14000, typically over a data network to a user computer, operating user recommendation electronic widget 130.

In step 440 (shown in FIG. 13), input is received into system 14000 (shown in FIG. 14) from the user on one or more of the displayed articles and products. In an embodiment of the present invention, this input is a click (via a mouse or other input device) on data item or on-line button.

In step 460, the system may find an article or product similar to an article favourably rated. This may be performed using any content-related algorithm such as the content similarity approaches described above. A favourable rating may be an indication that the user has clicked on the article or clicked to display the entire article. Alternatively, the input received in step 440 could be user ratings or indications a user has dismissed products or articles.

In step 470, one or more of the displayed articles and products (or information about them) is replaced, based on the user input. Typically, a new article or articles or a new product or products would be provided.

Referring again to FIG. 14, 14030, 14050, 14070 have been described as separate databases. In a preferred embodiment they are different data structures on a common physical database.

Referring to FIG. 15, steps 15040, 15050 and 15060 provide steps in a method of generating a list of similar products. In an alternative embodiment of the present invention, when providing a list of recommended products from a sophisticated on-line vendor such as Amazon, it may be sufficient to provide some key-words (such as words from the content similarity approach to the Amazon search engine and then the Amazon site would return URLs (web-pages) pointing to or displaying products similar to the tags or words, where such returned web-pages would also facilitate ordering such products. With other vendors with less sophisticated web-sites, some enablement of on-line ordering might be required. In an embodiment of the present invention, the information displayed about the product contains a product name, such as a book title, and a link to the vendor's website.

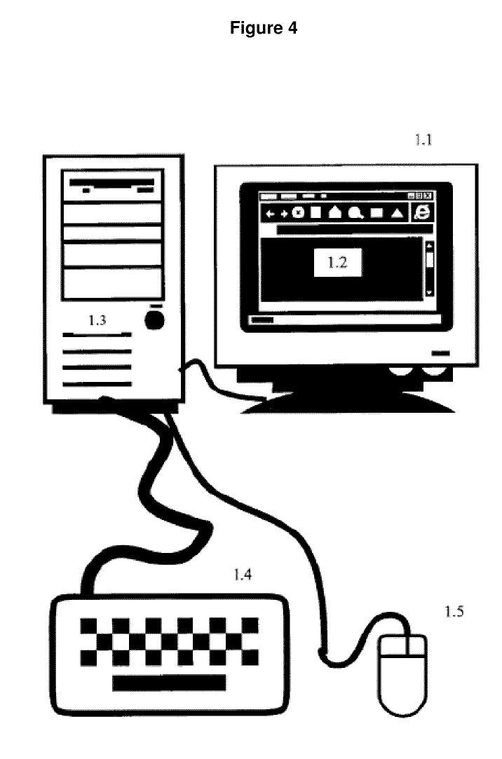

FIG. 4 shows a general computer system on which the invention might be practiced. The general computer system comprises of a display device (1.1) with a display screen (1.2). Examples of display device are Cathode Ray Tube (CRT) devices, Liquid Crystal Display (LCD) Devices etc. The general computer system can also have other additional output devices like a printer. The cabinet (1.3) houses the additional basic components of the general computer system such as the microprocessor, memory and disk drives. In a general computer system the microprocessor is any commercially available processor of which x86 processors from Intel and 680X0 series from Motorola are examples. Many other microprocessors are available. The general computer system could be a single processor system or may use two or more processors on a single system or over a network. The microprocessor for its functioning uses a volatile memory that is a random access memory such as dynamic random access memory (DRAM) or static memory (SRAM). The disk drives are the permanent storage medium used by the general computer system. This permanent storage could be a magnetic disk, a flash memory and a tape. This storage could be removable like a floppy disk or permanent such as a hard disk. Besides this the cabinet (1.3) can also house other additional components like a Compact Disc Read Only Memory (CD-ROM) drive, sound card, video card etc. The general computer system also had various input devices like a keyboard (1.4) and a mouse (1.5). The keyboard and the mouse are connected to the general computer system through wired or wireless links. The mouse (1.5) could be a two-button mouse, three-button mouse or a scroll mouse. Besides the said input devices there could be other input devices like a light pen, a track ball, etc. The microprocessor executes a program called the operating system for the basic functioning of the general computer system. The examples of operating systems are UNIX™, WINDOWS™ and OS X™. These operating systems allocate the computer system resources to various programs and help the users to interact with the system. It should be understood that the invention is not limited to any particular hardware comprising the computer system or the software running on it.

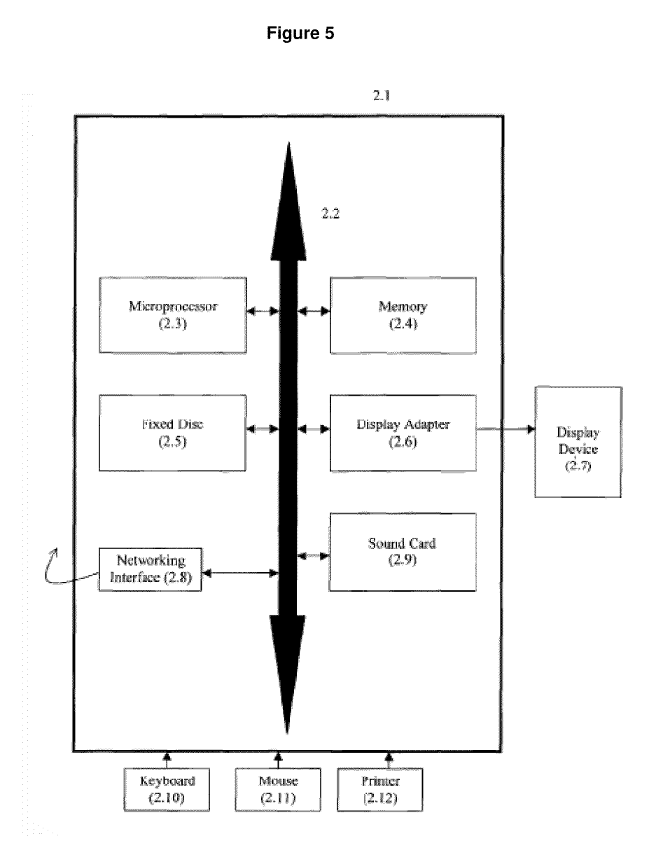

FIG. 5 shows the internal structure of the general computer system of FIG. 5. The general computer system (2.1) consists of various subsystems interconnected with the help of a system bus (2.2). The microprocessor (2.3) communicates and controls the functioning of other subsystems. Memory (2.4) helps the microprocessor in its functioning by storing instructions and data during its execution. Fixed Drive (2.5) is used to hold the data and instructions permanent in nature like the operating system and other programs. Display adapter (2.6) is used as an interface between the system bus and the display device (2.7), which is generally a monitor. The network interface (2.8) is used to connect the computer with other computers on a network through wired or wireless means. The system is connected to various input devices like keyboard (2.10) and mouse (2.11) and output devices like printer (2.12). Various configurations of these subsystems are possible. It should also be noted that a system implementing the present invention might use less or more number of the subsystems than described above. The computer screen which displays the recommendation results can also be a separate computer system than that which contains components such as database 360 and the other modules described above.

In another embodiment, the computer system will include a receiver module for receiving information regarding one or more articles. The system will also include a processor module, for determining replacement information to be displayed, based on the user input. The system will also include a changer module, for switching between views to be displayed.

What has been described above includes examples of the present invention. It is, of course, not possible to describe every conceivable combination of components or methodologies for purposes of describing the present invention, but one of ordinary skill in the art may recognize that may further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

It will be understood that the above description of the present invention is susceptible to various modifications, changes and adaptations, and the same are intended to be comprehended within the meaning and range of equivalents of the appended claims.

What is claimed is:

1. In a data processing system, a method of recommending items to a user comprising:
(a) receiving content of an article at an input of a processor;
(b) the processor creating a frequency occurrence vector in relation to the content;
(c) receiving an intermediate data set in relation to each of one or more products at an input of the processor;
(d) the processor creating intermediate data vectors in relation to each of the one or more products from the intermediate data;
(e) the processor comparing the frequency occurrence vector to the intermediate data vectors to determine a content similarity measure between the frequency occurrence vector and each of the intermediate data vectors; and,
(f) providing at an output of the processor, a list comprising one or more products associated with the intermediate data vectors having the highest content similarity measure to the frequency occurrence vector.

2. A method of recommending items to a user according to claim 1 further comprising:
(a) receiving content of a second article at the input of the processor;
(b) repeating steps b-f of claim 1, thereby producing a second list comprising a second set of one or more products associated with the intermediate data vectors having the highest content similarity measure to the frequency occurrence vector of the content of the second article;
(c) the processor applying weighting factors to the products found on the list and second list;
(d) the processor adding the weighting factors associated with products found on both the list and the second list, thereby combining the lists; and,
(e) the processor presenting a list comprising the one or more products having the highest aggregate weighting factors.

3. A method of recommending items to a user according to claim 1 further comprising: using a cosine similarity measure to determine the content similarity measure between the frequency occurrence vector and each of the intermediate data vectors.

4. A method of recommending items to a user according to claim 1 further comprising: including in the list comprising one or more products associated with the intermediate data vectors having the highest content similarity measure to the frequency occurrence vector, information about the article.

5. A method of recommending items to a user according to claim 1, wherein the list comprising the one or more products associated with the intermediate data vectors having the highest content similarity measure to the frequency occurrence vector further comprises a link to each vendor offering said one or more products for purchasing the said one or more products on the list.

6. A method of recommending items to a user according to claim 1, wherein the list comprising one or more products associated with the intermediate data vectors having the highest content similarity measure to the frequency occurrence vector, is determined by selecting those products having the highest n content similarity measures, where n is an integer.

7. A method of recommending items to a user according to claim 1, wherein the list comprising one or more products associated with the intermediate data vectors having the highest content similarity measure to the frequency occurrence vector, is determined by selecting those products having a content similarity measure which exceeds an operator determined threshold.

8. A method of recommending items to a user according to claim 1 further comprising: displaying, in a user recommendation electronic widget, the list comprising the article and the one or more products associated with the intermediate data vectors having the highest content similarity measure to the frequency occurrence vector on a user display screen.

9. A method of recommending items to a user according to claim 8 further comprising:
(a) receiving from a user of said user recommendation electronic widget, a signal indicating the user's desire to purchase one of the one or more products; and,
(b) transmitting to a vendor of said desired product, using a user recommendation electronic widget, a signal indicating the user's desire to purchase the said one desired product.

10. A method of recommending articles and products to a user, comprising:
(a) receiving content of an article at an input of a processor using an electronic recommender system;
(b) creating a frequency occurrence vector in relation to the content of the article using said electronic recommender system;
(c) receiving intermediate data in relation to each of one more products using said electronic recommender system;
(d) creating intermediate data vectors in relation to each of the products from the intermediate data using said electronic recommender system;
(e) comparing the frequency occurrence vector to the intermediate data vectors to determine a content similarity measure between the frequency occurrence vector and each of the intermediate data vectors using said electronic recommender system;
(f) providing a list comprising the one or more products associated with the intermediate data vectors having the highest content similarity measure to the frequency occurrence vector using said electronic recommender system.

11. A method of recommending articles and products to a user and facilitating user purchase of one or more of the recommended products, comprising:
(a) receiving at a user display a list comprising a recommended article and one or more recommended products;
(b) receiving from a user using a user recommendation electronic widget, a signal indicating the user's desire to purchase one of the recommended products;
(c) transmitting to a vendor of said desired product, using a user recommendation electronic widget, a signal indicating the user's desire to purchase the said product.

12. A method of recommending products comprising:
(a) receiving an article using an electronic user recommendation system;
(b) receiving information for each of one or more products using said electronic user recommendation system;
(c) determining a content similarity measure between the article and the information for each of said plurality of products using said electronic user recommendation system; and
(d) generating a list comprising the article and one or more of said plurality of products having the highest content similarity measure using said electronic user recommendation system.

13. The method of recommending products claimed in claim 12, further comprising:
(a) receiving input from a plurality of users on items co-visited within a given time interval using an electronic user recommendation system;
(b) receiving input from a new user on an item visited; and
(c) generating a recommended product to the new user by selecting the product which is most frequently co-visited with the item visited by the new user.

14. A method of recommending articles and products according to claim 12, further comprising:
(a) determining the total number of unique visits for each item visited; and,
(b) applying a weighting factor to the number of determined co-visits by dividing the number of co-visits by the number of visits to the item visited by the new user.

15. A method of recommending products according to claim 12, further comprising determining a recommendation score for a candidate product comprising the following steps:
(a) receiving input from a plurality of users on items co-visited within a given time interval using an electronic user recommendation system;
(b) receiving a history of items visited by a new user using an electronic user recommendation system;
(c) calculating a personal co-visitation score for the new user, according to the following formula using an electronic user recommendation system:
$$\frac{\frac{f ( a , candidate )}{f ( a )} + \frac{f ( b , candidate )}{f ( b )} + … + \frac{f ( n , candidate )}{f ( n )}}{n}$$
where (a, b, . . . n are items visited by the user); f(n,candidate) is the number of people who have co-visited item n and the candidate product; and, f(n) is the number of people who have visited item n; and n is the total number of items visited by the user.

16. An electronic data processing system for recommending articles and products to a user, comprising:
(a) an article information receiver module, for receiving content of an article;
(b) a correlation module for creating a frequency occurrence vector in relation to the article content;
(c) a product information receiver module for receiving intermediate data in relation to each of one or more products;
(d) said correlation module creating intermediate data vectors in relation to each of the products from the intermediate data;
(e) said correlation module comparing the frequency occurrence vector to the intermediate data vectors to determine a content similarity measure between the frequency occurrence vector and each of the intermediate data vectors; and,
(f) a multiplexer module for providing a list comprising the article and the one or more products associated with the intermediate data vectors having the highest content similarity measure to the frequency occurrence vector.

17. An electronic data processing system for recommending articles and products to a user according to claim 16 wherein the correlation module also determines a correlation measure between the article and the one or more products and wherein the list comprises one or more products having the highest correlation measure.

18. An electronic data processing system for recommending articles and products to a user according to claim 17 wherein the correlation measure is determined by a co-visitation approach.

19. An electronic data processing system for recommending articles and products to a user according to claim 16 wherein the list provided by the multiplexer module also comprises popular articles as determined by click-through data captured by a user recommendation electronic widget.
